(19) United States
(12) Patent Application Publication
(10) Pub. No.: US 2012/0167174 A1
(43) Pub. Date: Jun. 28, 2012

(54) TRUSTED EMAIL SENDER INDICATORS

(75) Inventors: Sanchan Sahai Saxena, San Francisco, CA (US); Krishna Vitaldevara, Fremont, CA (US); Eliot C. Gillum, Mountain View, CA (US); Tyler J. Schnoebelen, San Francisco, CA (US); Brian A. Carter, San Mateo, CA (US); Carlos A. Madrigal, San Jose, CA (US); Samuel H. Mandell, Palo Alto, CA (US)

(73) Assignee: MICROSOFT CORPORATION, Redmond, WA (US)

(21) Appl. No.: 12/978,918

(22) Filed: Dec. 27, 2010

(51) Int. Cl. G06F 21/00; G06F 15/16

(52) U.S. Cl. 726/3; 709/206

(57) ABSTRACT

In embodiments of trusted email sender indicators, email messages are received for distribution, and validation techniques can be applied to determine whether a sender of an email message is trusted. If the sender of the email message is determined to be trusted, a trusted sender indicator can be associated with the email message for display with the email message. The trusted sender indicator indicates that the email message is from a trusted sender, such as when the trusted sender indicator is displayed along with the email message at a recipient client device.

### BACKGROUND

Phishing and spoofing attacks attempt to acquire sensitive information from email recipients by sending email messages that appear to be from a trusted source, such as a well-known company or financial institution. Email recipients must be careful, therefore, when responding to or interacting with email messages to ensure that sensitive information, such as bank account numbers, usernames, and passwords, are not communicated to an untrusted source. As a result, some email recipients unknowingly communicate sensitive information to untrusted sources that attempt to solicit personal information, while other email recipients simply ignore email messages received from legitimate sources out of fear that personal information may be obtained and used to their detriment.

### SUMMARY

This summary is provided to introduce simplified concepts of trusted email sender indicators that are further described below in the Detailed Description. This summary is not intended to identify essential features of the claimed subject matter, nor is it intended for use in determining the scope of the claimed subject matter.

Trusted email sender indicators are described. In embodiments, email messages are received for distribution, and validation techniques can be applied to determine whether a sender of an email message is trusted. If the sender of the email message is determined to be trusted, a trusted sender indicator can be associated with the email message for display with the email message. The trusted sender indicator indicates that the email message is from a trusted sender, such as when the trusted sender indicator is displayed along with the email message at a recipient client device.

In other embodiments, an email trust service can be implemented to determine whether the sender of an email message is trusted, and verify that the sender of the email message is included in a trusted sender list. The sender of an email message can be validated by SenderID, and/or the email message can be validated by Domain Keys Identified Mail (DKIM) authentication. Alternatively or in addition, a domain and/or sub-domain from which an email message is received can be validated to determine that a sender of the email message is trusted. If the sender of an email message is trusted, a displayable version of the email message can be generated for display at a recipient client device along with a trusted sender indicator. Alternatively or in addition, a list view of email messages can be generated for display at the recipient client device, where the list view displays with trusted sender indicators to indicate the email messages that are received from respective trusted senders.

### BRIEF DESCRIPTION OF THE DRAWINGS

Embodiments of trusted email sender indicators are described with reference to the following drawings. The same numbers are used throughout the drawings to reference like features and components:

FIG. 1 illustrates an example system in which embodiments of trusted email sender indicators can be implemented.

FIG. 2 illustrates an example of a trusted email message displayed at a client device in accordance with one or more embodiments.

FIG. 3 illustrates another example of a display list of email messages displayed at a client device in accordance with one or more embodiments.

FIG. 4 illustrates an example system with multiple devices for a seamless user experience in ubiquitous environments.

FIG. 5 illustrates example method(s) of trusted email sender indicators in accordance with one or more embodiments.

FIG. 6 illustrates additional example method(s) of trusted email sender indicators in accordance with one or more embodiments.

FIG. 7 illustrates various components of an example device that can implement embodiments of trusted email sender indicators.

### DETAILED DESCRIPTION

Trusted email sender indicators are described. In embodiments, email messages are received at an email distribution service for distribution to client devices. Validation techniques can be applied to determine whether a sender of an email message is trusted. Determining whether a sender of an email message is trusted includes verifying that the sender is on a trusted sender list. In addition, determining whether a sender is trusted includes validating the sender of an email message by SenderID, and/or validating the email message by Domain Keys Identified Mail (DKIM) authentication. The validation techniques may include validating a domain name or an IP address from which the email message was received to determine that the sender of the email message is trusted.

Additionally, if the sender of the email message is determined to be trusted, a trusted sender indicator can be associated with an email message for display with the email message. A trusted sender indicator displayed with an email message may establish user trust that an email message is safe to open and/or reply to the sender of the email message. A user may be more confident and trusting of an email message when seeing a visual indication of trust, such as may be encountered when interacting with a browser user interface.

In embodiments, a displayable version of the email message can then be generated for display at a recipient client device along with the trusted sender indicator, indicating to a recipient of the email message that the email message is from a trusted sender. In other embodiments, a list view of email messages can be generated for display at the recipient client device along with trusted sender indicators that indicate to a recipient of the email messages which of the email messages are received from respective trusted senders. Alternatively or in addition, negative indicators may be associated with email messages that are received from senders that are not trusted. The recipient client device may display the negative indicators to indicate email messages that are not trusted or that are not from trusted senders. Whereas a list view of trusted email messages may include mostly trusted sender indicators, the list view can be switched to display fewer negative indicators so that email messages that are not trusted are easily identifiable in the list.

In another embodiment, trusted email messages can be identified for a recipient client device, which then selects a device-selected or user-designated version of a trusted sender indication for display at the client device. A client device can request that an email trust service indicate whether a sender of an email message is trusted or not, and then the client device can display a different type of trusted sender indication, such as may be relevant in a context to the recipient of the email message.

While features and concepts of the described systems and methods for trusted email sender indicators can be implemented in any number of different environments, systems, devices, and/or various configurations, embodiments of trusted email sender indicators are described in the context of the following example devices, systems, and configurations.

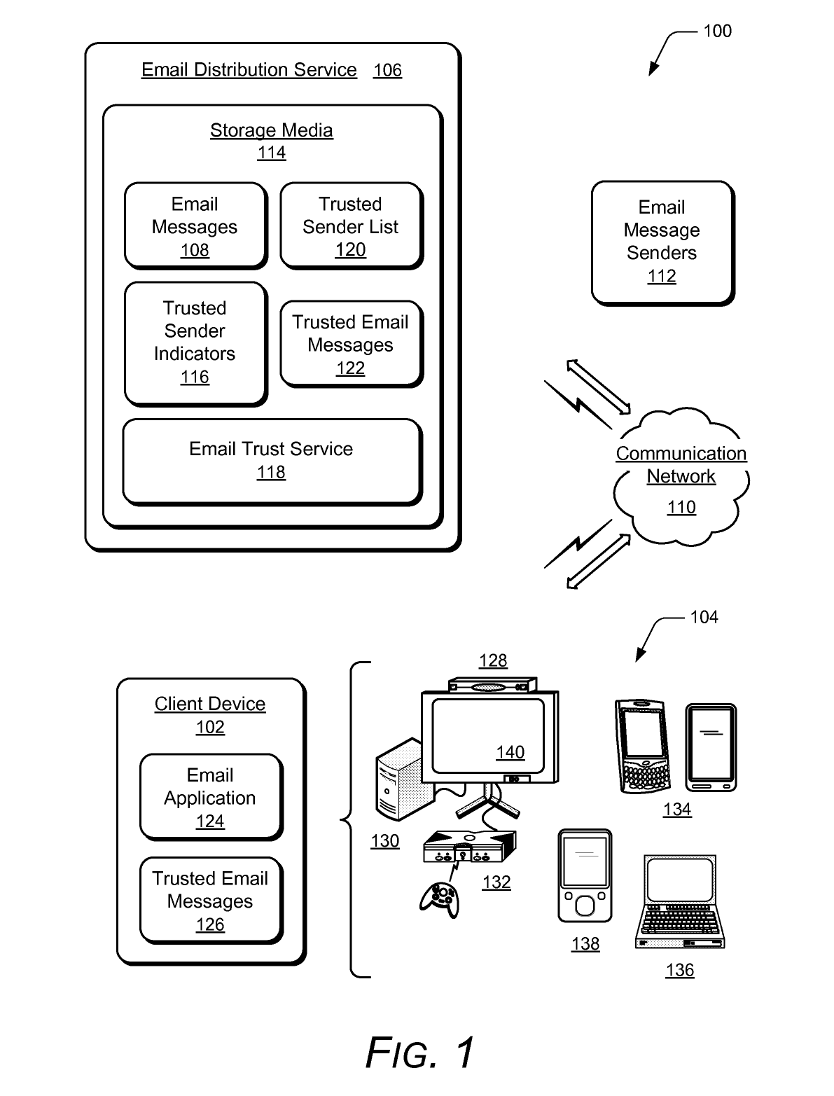

FIG. 1 illustrates an example system 100 in which various embodiments of trusted email sender indicators can be implemented. The example system 100 includes a client device 102, which may be configured as any type of client device 104. Some of the various client devices include wired and/or wireless devices, and may also be referred to as user devices and/or portable devices. The example system 100 also includes an email distribution service 106 that receives email messages 108 for distribution to the various client devices that correspond to respective recipients of the email messages. The email distribution service can communicate an email message to a client device 104 via a communication network 110.

Any of the services and devices can communicate via the communication network 110, which can be implemented to include a wired and/or a wireless network that facilitates email message distribution and data communication. The communication network can also be implemented using any type of network topology and/or communication protocol, and can be represented or otherwise implemented as a combination of two or more networks. The communication network may also include mobile operator networks that are managed by mobile operators, such as a communication service provider, cell-phone provider, and/or Internet service provider. A mobile operator can facilitate mobile data and/or voice communication for any type of a wireless device or mobile phone (e.g., cellular, VoIP, Wi-Fi, etc.).

The email distribution service 106 can include server devices to receive email messages, such as from various email message senders 112 and communicate, or otherwise distribute, the received email messages to any number of the various client devices for the intended recipients of the email messages. In this example system 100, the email distribution service includes storage media 114 to store or otherwise maintain various data, such as the email messages 108 and trusted sender indicators 116. The storage media can be implemented as any type of memory and/or suitable electronic data storage. Additionally, the email distribution service may be implemented as a subscription-based service from which any of the various client devices 104 can request email messages. The email distribution service manages email message distribution to the various client devices, such as when a request for an email message is received from a client device, and the email distribution service communicates or provides data segments of the email message to the client device.

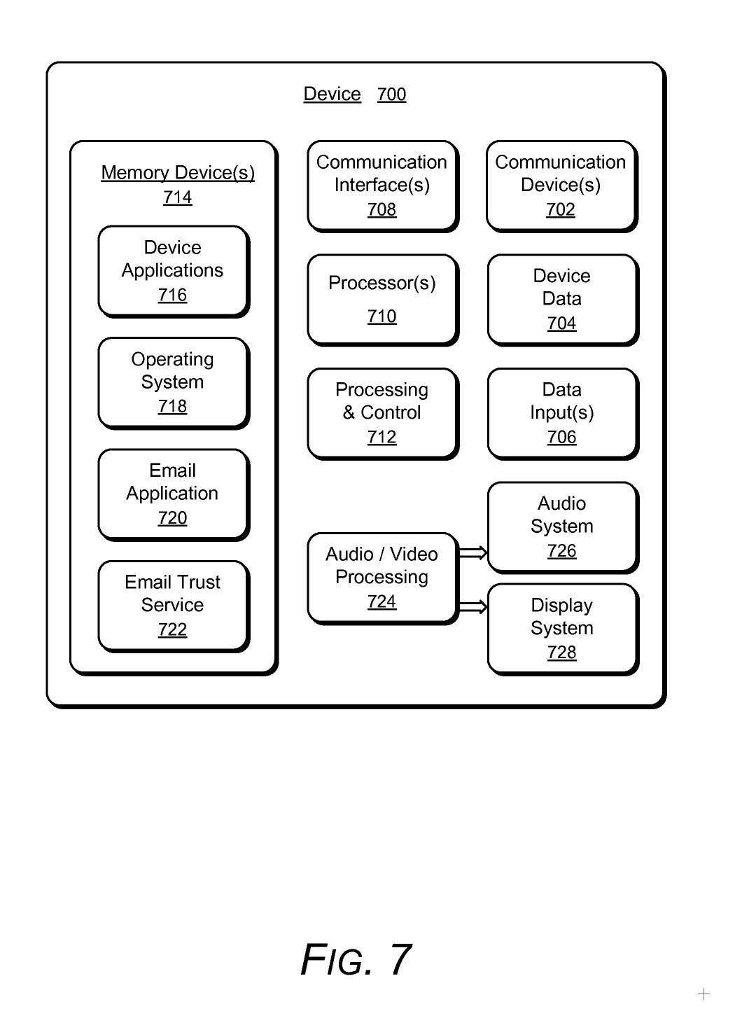

In this example system 100, the email distribution service 106 includes an email trust service 118 that can be implemented as computer-executable instructions, such as a software application, and executed by one or more processors to implement the various embodiments described herein. The email distribution service can also be implemented with any number and combination of differing components as further described with reference to the example device shown in FIG. 7. Additionally, the email trust service may be implemented as an independent service separate from the email distribution service (e.g., on a separate server, by a third party service, or on a client device).

In various embodiments, the email trust service 118 is implemented to determine whether an email message 108 can be trusted, such as whether a sender of an email message is included in a trusted sender list 120. The email trust service is then implemented to associate a trusted sender indicator 116 with the email message to generate a trusted email message 122.

To determine whether an email message 108 is trusted, the email trust service 118 is implemented to verify that the email message is received from a sender that is included in the trusted sender list 120, such as a well-known company, financial institution, or other legitimate business from a trusted domain, or a sub-domain of a trusted domain. In embodiments, the email trust service can extract data about the sender of an email message from the email message, such as the domain from where the email was sent; compare the data about the sender to pre-established criteria, such as the trusted sender list 120; and then determine that the sender is trusted when the data about the sender correlates to the pre-established criteria.

Various validation techniques can also be applied by the email trust service 118 to determine whether a sender of an email message 108 is trusted. For example, the email trust service can apply SenderID techniques to validate a sender of an email message, and/or Domain Keys Identified Mail (DKIM) authentication techniques to validate the email message. Both DKIM and SenderID can be used to verify that the sender of an email message is included in the trusted sender list 120.

When the sender of an email message is determined to be a trusted sender, the email trust service 118 is implemented to then associate a trusted sender indicator 116 with the email message 108 to generate a trusted email message 122. A trusted sender indicator 116 can be any type of image, graphic, text, or sound indication that an email message is trusted. In embodiments, a trusted sender indicator 116 can be associated with a trusted email message 122 for display with the trusted email message. Alternatively or in addition, negative indicators may be associated with email messages that are received from senders that are not trusted. A negative indicator can also be any type of image, graphic, text, or sound indication that an email message is not trusted.

The example client device 102 includes an email application 124 that can request, receive, and process email messages for a user at the client device. The client device can receive a trusted email message 126 from the email distribution service 106, such as when a user at the client device initiates the email application. The client device 102 can then display the trusted email message along with a trusted sender indicator that indicates to a recipient of the email message that the email message is from a trusted sender. Alternately or in addition, the client device 102 can display the trusted email messages in a list view along with trusted sender indicators proximate the trusted email messages to indicate to a recipient of the email messages that the email messages that are from a trusted sender. In an alternate embodiment, the client device can display negative indicators, such as a negative icon, to indicate email messages that are not trusted or that are not from trusted senders. Whereas a list view of trusted email messages may include mostly trusted sender indicators, the list view can be switched to display fewer negative indicators so that email messages that are not trusted are easily identifiable in the list.

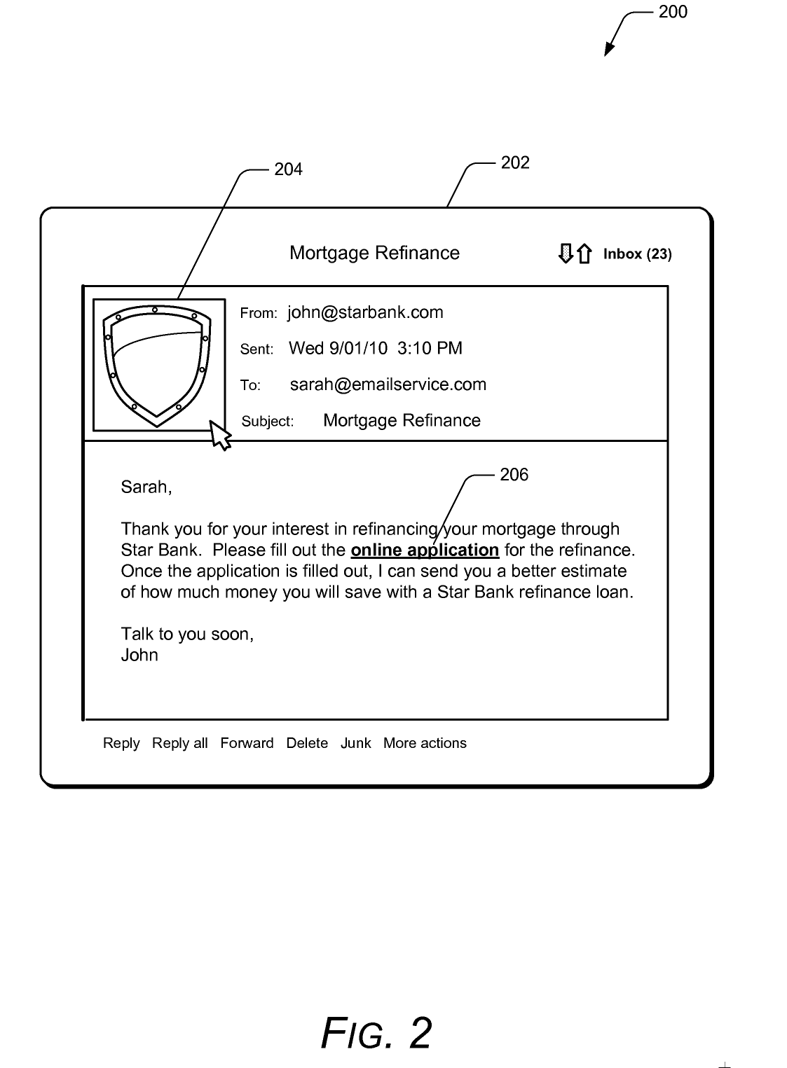

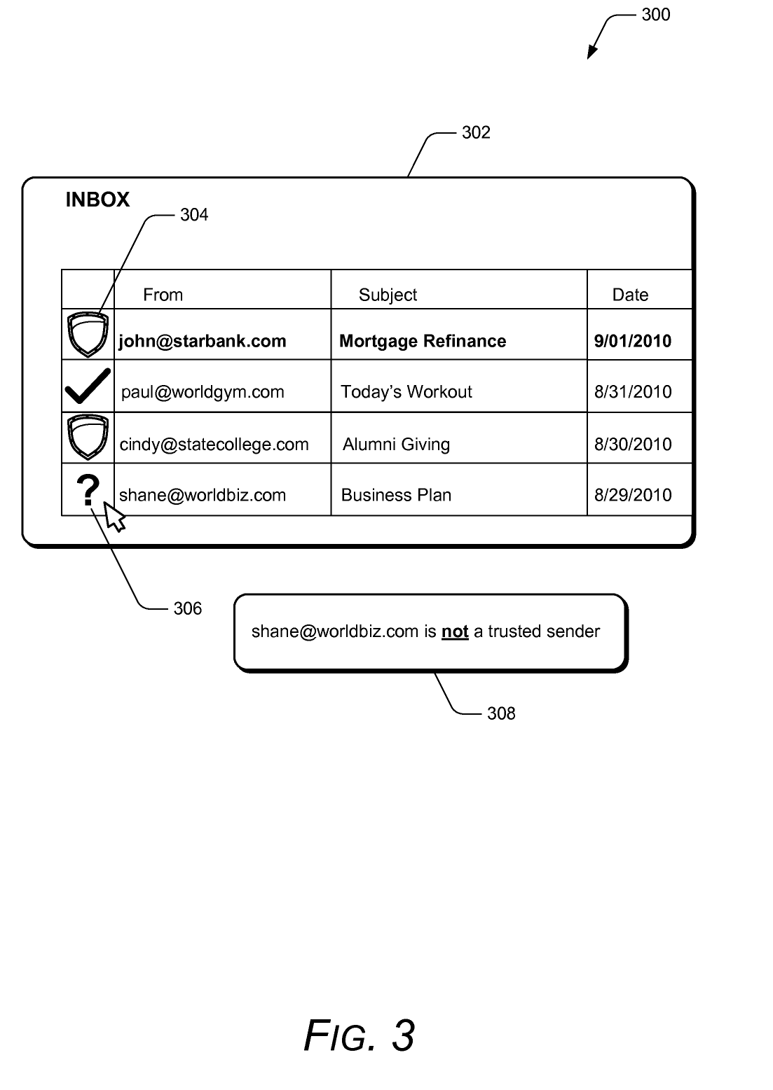

The email distribution service 106 can receive a request for the email messages 108 from the client device 102, and then generate a displayable version of a trusted email message 122 that is communicated to the client device for display as a trusted email message 126. The trusted email message can be displayed along with the associated trusted sender indicator, to indicate to a recipient of the email message that the sender of the email message is a trusted sender. In another embodiment, the email trust service 118 at the email distribution service can indicate trusted email messages for the client device, which then selects a device-selected or user-designated version of a trusted sender indication for display at the client device. A client device can request that the email trust service indicate whether a sender of an email message is trusted or not, and then the client device can display a different type of trusted sender indication, such as may be relevant in a context to the recipient of the email message. Examples of displaying a trusted sender indicator along with an email message at a client device are illustrated and described with reference to FIGS. 2 and 3 below.

Any of the various client devices 104 can be configured as the client device 102, and may be implemented with any number and combination of differing components as further described with reference to the example device shown in FIG. 7. In this example system 100, a client device 104 can be implemented as any one or combination of a television client device 128, a computer device 130, a gaming system 132, an appliance device, an electronic device, and/or as any other type of device that may be implemented to receive content (e.g., email messages) in any form of audio, video, and/or image data. The various client devices can also include wireless devices implemented to receive and/or communicate wireless data, such as any one or combination of a mobile phone 134 (e.g., cellular, VoIP, WiFi, etc.), a portable computer device 136, a media player device 138, and/or any other wireless device that can receive media content (e.g., email messages) in any form of audio, video, and/or image data. A client system can include a respective client device and display device 140 that together render email messages for display. The display device can be implemented as any type of a television, high definition television (HDTV), LCD, or similar display system.

FIG. 2 illustrates an example 200 of a trusted email message 202 displayed at a client device in accordance with the various embodiments described herein. The trusted email message is an example of a trusted email message 126 received at client device 102 as described with reference to FIG. 1. The trusted email message includes a trusted sender indicator 204 that provides an indication to a recipient of the trusted email message that the sender of the email message is trusted. In this example, “john” and/or the domain “starbank.com” are trusted senders of email messages. The trusted sender indicator can be displayed as any type of text, image, animation, color, sound, or other indication to an email recipient that the email is trusted.

In this example, the trusted sender indicator 204 is a shield icon. The display of the shield icon indicates to the email recipient that the sender of the email message is trusted, and the email recipient can confidently reply to the email message and/or interact with the email message, such as by selecting a hyperlink 206 that is included within the email message. In an embodiment, the trusted sender indicator 204 is also a user-selectable control that a user can select to initiate an interaction, such as to display a text box indicating to the recipient that the sender of the email message is trusted.

FIG. 3 illustrates an example 300 of a list view 302 of email messages displayed at a client device in accordance with various embodiments described herein. In this example, an indicator is displayed proximate each email message in the list view to indicate which of the email messages are trusted email messages received from respective trusted senders. For example, the email messages from “john@starbank.com” and “cindy@statecollege.com” are displayed in the list view and the trusted sender indicator 304 is displayed as a shield icon proximate each of the trusted email messages to indicate that the senders of the email messages are trusted.

The list view 302 of the email messages also includes an email message from “paul@worldgym.com” that includes a standard sender indicator displayed proximate the email message as a check mark. In this example, the email trust service has not determined that the sender of the email message from “paul@worldgym.com” is trusted, and a standard sender indicator is provided by the email trust service and displayed to indicate that the sender of the email message may or may not be trusted. Note that other types of standard sender indicators may be used instead of the check mark depicted in this example. For example, the list view 302 of the email messages also includes a message from “shane@worldbiz.com” that includes a standard sender indicator 306 displayed proximate the email message as a question mark. In an embodiment, the standard sender indicator 306 is also a selectable control that a user can select to initiate an interaction, such as to display a text box 308 that indicates to the email recipient that “shane@worldbiz.com” is likely not a trusted sender.

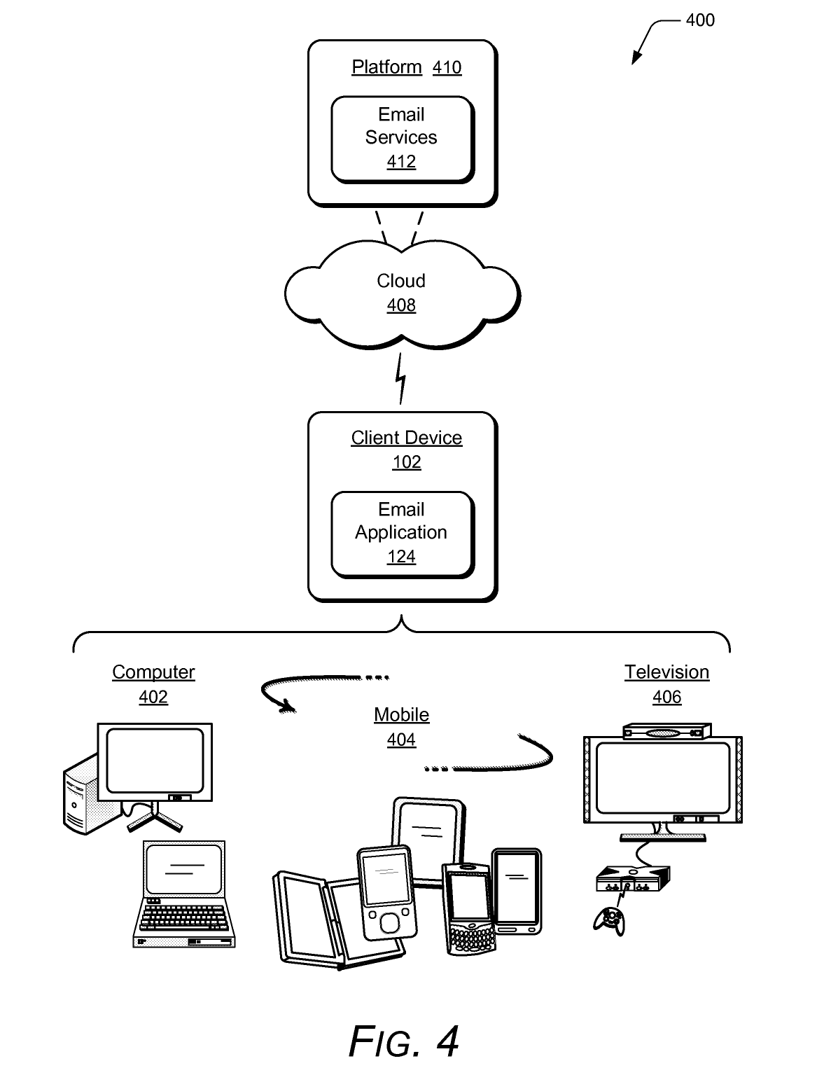

FIG. 4 illustrates an example system 400 that includes the client device 102 as described with reference to FIG. 1. The example system 400 enables ubiquitous environments for a seamless user experience when running applications on any type of computer, television, and/or mobile device. Services and applications run substantially similar in all environments for a common user experience when transitioning from one device to the next while utilizing an application, playing a video game, watching a video, listening to music, and so on.

In the example system 400, multiple devices can be interconnected through a central computing device, which may be local to the multiple devices or may be located remotely from the multiple devices. In one embodiment, the central computing device may be a cloud of one or more server computers that are connected to the multiple devices through a network, the Internet, or other data communication link. In embodiments, this interconnection architecture enables functionality across multiple devices to provide a common and seamless experience to a user of the multiple devices. Each of the devices may have different physical requirements and capabilities, and the central computing device uses a platform to enable delivery of an experience that is both tailored to a particular device and yet common to all of the devices. In one embodiment, a class of target devices is created and user experiences are tailored to the generic class of devices. A class of devices may be defined by physical features, types of usage, or other common characteristics of the devices.

In various implementations, the client device 102 may be implemented in a variety of different configurations, such as for computer 402, mobile 404, and television 406 uses. Each of these configurations includes devices that may have generally different constructs and capabilities, and the client device may be configured according to one or more of the different device classes. For example, the client device may be implemented as any type of a personal computer, desktop computer, a multi-screen computer, laptop computer, tablet, netbook, and so on.

The client device 102 may also be implemented as any type of mobile device, such as a mobile phone, portable music player, portable gaming device, a tablet computer, a multi-screen computer, and so on. The client device may also be implemented as any type of television device having or connected to generally larger screens in casual viewing environments. These devices include televisions, set-top boxes, gaming consoles, and so on. The techniques described herein may be supported by these various configurations of the client device and are not limited to the specific examples of trusted email sender indicators described herein.

The cloud 408 includes and/or is representative of a platform 410 for email services 412. The platform abstracts underlying functionality of hardware, such as server devices, and/or software resources of the cloud. The email services may include applications and/or data that can be utilized while computer processing is executed on servers that are remote from the client device. For example, the email services may include the email distribution service 106 and/or the email trust service 118 as described with reference to FIG. 1. The email services 412 can be provided as a service over the Internet and/or through a subscriber network, such as a cellular or WiFi network.

The platform 410 may abstract resources and functions to connect the client device 102 with other computing devices. The platform may also serve to abstract scaling of resources to provide a corresponding level of scale to encountered demand for the services that are implemented via the platform. Accordingly, in an interconnected device embodiment, implementation of functionality of the email application 124 may be distributed throughout the system 400. For example, the email application 124 may be implemented in part on the client device as well as via the platform that abstracts the functionality of the cloud.

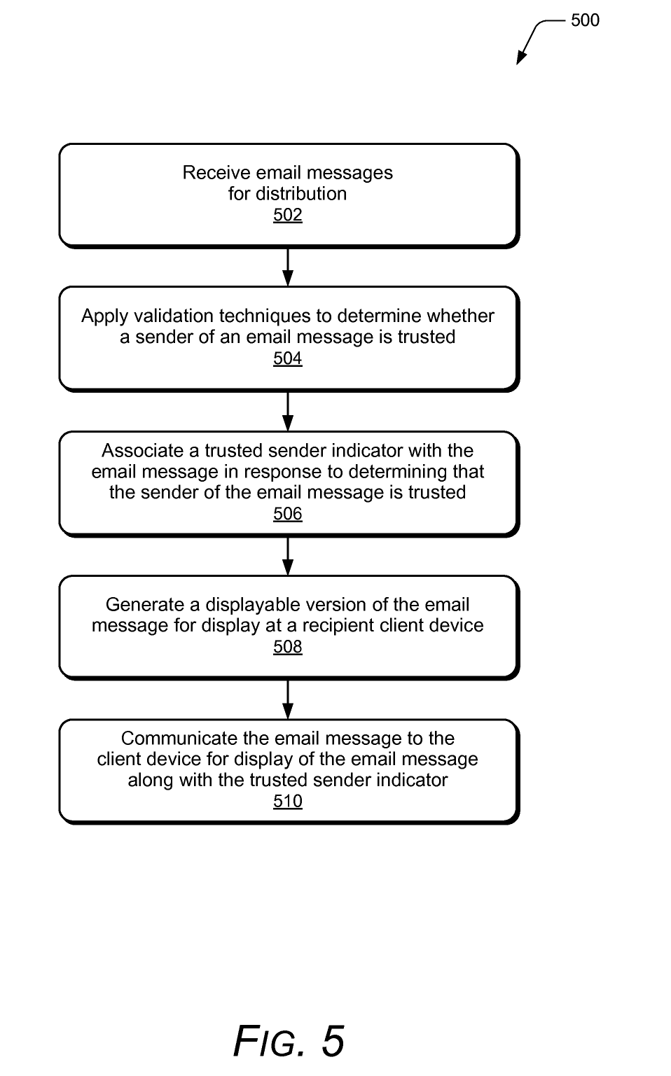

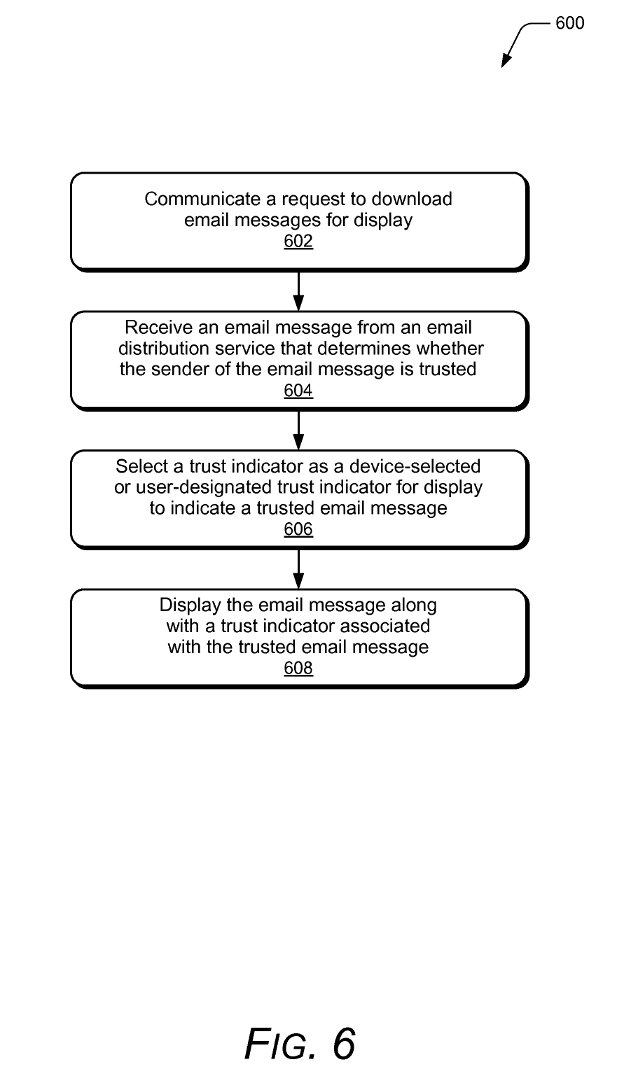

Example methods 500 and 600 are described with reference to respective FIGS. 5 and 6 in accordance with one or more embodiments of trusted email sender indicators. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 5 illustrates example method(s) 500 of trusted email sender indicators, and is described with reference to an email distribution service. The order in which the method blocks are described are not intended to be construed as a limitation, and any number of the described method blocks can be combined in any order to implement a method, or an alternate method.

At block 502, email messages are received for distribution. For example, the email distribution service 106 (FIG. 1) receives email messages 108 for distribution to the various client devices 104 that correspond to respective recipients of the email messages.

At block 504, validation techniques are applied to determine whether a sender of the email message is trusted. For example, to determine whether a sender of an email message 108 is trusted, the email trust service 118 verifies that the sender of the email message is included in a trusted sender list 120. If the sender of the email message is not included in the trusted sender list, the email trust service can associate a standard sender indicator with the email message to indicate to the email recipient that the sender of the email message is not trusted.

Additionally, the validation techniques may include validating the sender of the email message by SenderID and/or validating the email message by Domain Keys Identified Mail (DKIM) authentication. In embodiments, the email trust service can validate a domain or sub-domain from which the email message was received to determine that the sender of the email message is trusted. Alternatively, the email trust service can determine that the sender of the email message is not trusted when the email message is received from a non-validated sub-domain of a domain. In other embodiments, the email trust service can validate an IP address from which the email message was received to determine that the sender of the email message is trusted. If the email trust service does not determine that the sender of the email message is trusted, the email trust service can associate a standard sender indicator with the email message to indicate that the sender of the email message is not trusted.

In embodiments, other techniques may also be applied to determine whether a sender of an email message is trusted. For example, email trust service 118 may extract data about the sender of email message 108 from the email message, and compare the data to pre-established criteria. If the data about the sender correlates to the pre-established criteria, the email trust service can determine that the sender is trusted. Alternatively, if the data about the sender does not correlate to the pre-established criteria, the email trust service can determine that the sender is not trusted.

At block 506, a trusted sender indicator is associated with the email message in response to determining that the sender of the email message is trusted. For example, the email trust service 118 associates a trusted sender indicator 116 with an email message 108, to generate a trusted email message 122, such as when determining that the sender of the email message is included on the trusted sender list 120.

At block 508, a displayable version of the email message is generated by the email distribution service for display at a recipient client device. For example, the email distribution service 106 generates a displayable version of an email message, such as trusted email message 202 (FIG. 2), that includes the trusted sender indicator 204 to indicate to the email recipient that the sender of the email message is trusted. In embodiments, the email distribution service also generates a list view of email messages for display at the client device, where the list view includes trusted sender indicators that indicate which of the email messages are received from respective trusted senders. For example, the email distribution service 106 generates list view 302 for display at client device 102. The list view includes trusted sender indicators (e.g. trusted sender indicator 304 displayed as a shield icon) to indicate the trusted email messages that are received from trusted senders.

At block 510, the displayable version of the email message is communicated to the client device. For example, the email distribution service 106 communicates the displayable version of the email message 108 to client device 102 that corresponds to the recipient of the email message for display at the client device. Alternatively or in addition, the email distribution service communicates a list view of email messages to the client device for display.

FIG. 6 illustrates example method(s) 600 of trusted email sender indicators, and is described with reference to a client device. The order in which the method blocks are described are not intended to be construed as a limitation, and any number of the described method blocks can be combined in any order to implement a method, or an alternate method.

At block 602, a request is communicated to an email distribution service to download email messages for display. For example, the client device 102 (FIG. 1) communicates a request to the email distribution service 106 for email messages that have been sent to a user of the client device. At block 604, an email message is received from the email distribution service that determines whether the sender of the email message is trusted. For example, the email distribution service 106 determines that a sender of trusted email message 126 is trusted, and client device 102 receives the trusted email message from the email distribution service, such as when a user at the client device initiates the email application 124 to request, receive, and process email messages. Similarly, the email distribution service may determine that senders of additional email messages are trusted, and the client device receives the additional trusted email messages from the email distribution service.

At block 606, a trust indicator is optionally selected as a device-selected or user-designated trust indicator for display to indicate that the email message is from a trusted sender. For example, the client device 102 selects a device-selected or user-designated trust indicator for display to indicate that the email message is from a trusted sender. This may be an alternative to receiving a trusted sender indicator from the email distribution service. A client device can request that the email trust service 118 indicate whether a sender of an email message is trusted or not, and then the client device can display a different type of trusted sender indication, such as may be relevant in a context to the recipient of the email message.

At block 608, the email message is displayed along with a trusted sender indicator associated with the email message. For example, the client device 102 displays the trusted email message 126 (e.g., on a display device 140 or on an integrated display) along with a trusted sender indicator that is associated with the trusted email message. In embodiments, the trusted sender indicator is displayed proximate a trusted email message to indicate to the recipient of the email message that the email message is from a trusted sender. For example, the trusted sender indicator 204 (FIG. 2) is displayed as a shield icon proximate the trusted email message 202 to indicate that the email message is trusted. Similarly, the trusted sender indicator 304 (FIG. 3) is displayed as a shield icon proximate additional email messages in the list view 302 to indicate which emails are received from respective trusted senders, as determined by the email distribution service.

FIG. 7 illustrates various components of an example device 700 that can be implemented as any of the devices, or services implemented by devices, described with reference to the previous FIGS. 1-6. In embodiments, the device may be implemented as any one or combination of a fixed or mobile device, in any form of a consumer, computer, server, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 700 includes communication devices 702 that enable wired and/or wireless communication of device data 704, such as received data, data that is being received, data scheduled for broadcast, data packets of the data, etc. The device data or other device content can include configuration settings of the device, media content stored on the device, and/or information associated with a user of the device. Media content stored on the device can include any type of audio, video, and/or image data. The device includes one or more data inputs 706 via which any type of data, media content, and/or inputs can be received, such as user-selectable inputs, messages, communications, music, television content, recorded video content, and any other type of audio, video, and/or image data received from any content and/or data source.

The device 700 also includes communication interfaces 708, such as any one or more of a serial, parallel, network, or wireless interface. The communication interfaces provide a connection and/or communication links between the device and a communication network by which other electronic, computing, and communication devices communicate data with the device.

The device 700 includes one or more processors 710 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 712. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 700 also includes one or more memory devices (e.g., computer-readable storage media) 714 that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device.

Computer readable media can be any available medium or media that is accessed by a computing device. By way of example, and not limitation, computer readable media may comprise storage media and communications media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 714 provides data storage mechanisms to store the device data 704, other types of information and/or data, and various device applications 716. For example, an operating system 718 can be maintained as a software application with a memory device and executed on the processors. The device applications may also include a device manager, such as any form of a control application, software application, signal processing and control module, code that is native to a particular device, a hardware abstraction layer for a particular device, and so on.

In this example, the device applications 716 include an email application 720, such as when device 700 is implemented as a client device. Alternatively or in addition, the device applications include an email trust service 722, such as when the device is implemented as an email distribution service. The email application and the email trust service are shown as software modules and/or computer applications. Alternatively or in addition, the email application and/or the email trust service can be implemented as hardware, software, firmware, fixed logic, or any combination thereof.

The device 700 also includes an audio and/or video processing system 724 that generates audio data for an audio system 726 and/or generates display data for a display system 728. The audio system and/or the display system may include any devices that process, display, and/or otherwise render audio, video, display, and/or image data. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device.

Although embodiments of trusted email sender indicators have been described in language specific to features and/or methods, the subject of the appended claims is not necessarily limited to the specific features or methods described. Rather, the specific features and methods are disclosed as example implementations of the trusted email sender indicators.

1. A computer-implemented method, comprising:
receiving email messages for distribution;
applying one or more validation techniques to determine whether a sender of an email message is trusted; and
associating a trusted sender indicator for display with the email message to indicate that the email message is from a trusted sender responsive to determining that the sender of the email message is trusted.

2. A computer-implemented method as recited in claim 1, further comprising generating a displayable version of the email message for display at a recipient client device, the displayable version of the email message generated to display with the trusted sender indicator to indicate that the sender of the email message is trusted.

3. A computer-implemented method as recited in claim 1, further comprising generating a list view of the email messages for display at a recipient client device, the list view generated to display with trusted sender indicators to indicate the email messages that are received from respective trusted senders.

4. A computer-implemented method as recited in claim 3, further comprising switching the list view of the email messages to display with negative indicators to indicate the email messages that are received from respective senders that are not trusted.

5. A computer-implemented method as recited in claim 1, further comprising associating a standard sender indicator with the email message responsive to determining that the sender of the email message is not trusted.

6. A computer-implemented method as recited in claim 1, further comprising validating a domain from which the email message was received to determine that the sender of the email message is trusted.

7. A computer-implemented method as recited in claim 6, further comprising at least one of determining that the sender of the email message is trusted when the email message is received from a validated sub-domain of the domain, or determining that the sender is not trusted when the email message is received from a non-validated sub-domain of the domain.

8. A computer-implemented method as recited in claim 1, further comprising validating an IP address from which the email message was received to determine that the sender of the email message is trusted.

9. A computer-implemented method as recited in claim 1, further comprising determining that the sender of the email message is trusted based on more than just the sender being a designated email Contact of an email recipient.

10. A computer-implemented method as recited in claim 1, wherein determining that the sender of the email message is trusted includes:
verifying that the sender of the email message is included in a trusted sender list; and
at least one of validating the sender of the email message by SenderID, or validating the email message by Domain Keys Identified Mail (DKIM) authentication.

11. A system, comprising:
an email distribution service configured to receive email messages;
at least a memory and a processor to implement an email trust service configured to:
apply one or more validation techniques to determine whether a sender of an email message is trusted;
associate a trusted sender indicator for display with the email message to indicate that the email message is from a trusted sender responsive to determining that the sender of the email message is trusted; and
the email distribution service further configured to generate a displayable version of the email message for display at a recipient client device, the displayable version of the email message generated to display with the trusted sender indicator to indicate that the sender of the email message is trusted.

12. A system as recited in claim 11, wherein the email distribution service is further configured to generate a list view of the email messages for display at the recipient client device, the list view generated to display with trusted sender indicators to indicate the email messages that are received from respective trusted senders.

13. A system as recited in claim 11, wherein the email trust service is further configured to at least one of validate a domain from which the email message was received or validate an IP address from which the email message was received to determine that the sender of the email message is trusted.

14. A system as recited in claim 13, wherein the email trust service is further configured to at least one of determine that the sender of the email message is trusted when the email message is received from a validated sub-domain of the domain, or determine that the sender of the email message is not trusted when the email message is received from a non-validated sub-domain of the domain.

15. A system as recited in claim 11, wherein the email trust service is further configured to:
extract data about the sender of the email message from the email message;
compare the data about the sender to pre-established criteria; and
determine that the sender is trusted when the data about the sender correlates to the pre-established criteria.

16. A system as recited in claim 11, wherein to determine that the sender of the email message is trusted, the email trust service is further configured to:
verify that the sender of the email message is included in a trusted sender list; and
at least one of validate the sender of the email message by SenderID, or validate the email message by Domain Keys Identified Mail (DKIM) authentication.

17. A computer-implemented method, comprising:
communicating a request to download an email message for display;
receiving the email message from an email distribution service that determines whether a sender of the email message is trusted; and
displaying the email message along with a trusted sender indicator that indicates the email message is from a trusted sender.

18. A computer-implemented method as recited in claim 17, further comprising:
receiving additional email messages from the email distribution service; and
displaying a list view of the additional email messages, the list view including trusted sender indicators that indicate which of the additional email messages are received from respective trusted senders, as determined by the email distribution service.

19. A computer-implemented method as recited in claim 17, wherein the trusted sender indicator indicates that the email distribution service at least one of validated a domain from which the email message was received, or validated an IP address from which the email message was received to determine that the sender of the email message is trusted.

20. A computer-implemented method as recited in claim 17, further comprising selecting the trusted sender indicator as at least one of a device-selected or user-designated trust indicator for display to indicate that the email message is from a trusted sender.
